(19) United States
(12) Patent Application Publication
(10) Pub. No.: US 2019/0272938 A1
(43) Pub. Date: Sep. 5, 2019

(54) INDUCTOR MOLDED ON AN INSULATIVE PLASTIC BLOCK

(71) Applicant: AJOHO ENTERPRISE CO., LTD., Taipei (TW)

(72) Inventors: Chia-Ping MO, Taipei (TW); You-Chi LIU, Taipei (TW)

(21) Appl. No.: 16/417,005

(22) Filed: May 20, 2019

Related U.S. Application Data
(63) Continuation-in-part of application No. 15/972,814, filed on May 7, 2018.

(30) Foreign Application Priority Data
Nov. 2, 2017 (TW) 106137962

(51) Int. Cl. H01F 27/24; H01F 27/28; H01F 1/34

(52) U.S. Cl. CPC H01F 27/24; H01F 1/344; H01F 27/2823

(57) ABSTRACT

An inductor includes an insulative plastic block having a block base with a recessed open chamber, a positioning unit including odd-numbered rows of U-shaped plates and even-numbered rows of U-shaped plates arranged in a staggered manner in the recessed open chamber of the block base of the insulative plastic block, and a plurality of conductors respectively formed on the U-shaped plates and spaced from one another, each conductor having two opposite ends thereof respectively terminating in a lead outside the block base.

This application is a Continuation-In-Part of co-pending application Ser. No. 15/972,814, filed on May 7, 2018, for which priority is claimed under 35 U.S.C. § 120, the entire contents of which are hereby incorporated by reference.

This application claims the priority benefit of Application number 106137962 filed in Taiwan on Nov. 2, 2017.

### BACKGROUND OF THE INVENTION

### 1. Field of the Invention

The present invention relates to magnetic technologies and more particularly, to an inductor molded on an insulative plastic block, which comprises an insulative plastic block, rows of U-shaped plates of positioning unit mounted in the insulative plastic block in a staggered manner and conductors respectively formed on the U-shaped plates, magnetic cores of magnetic conductive components mounted in the insulative plastic block, and a connection carrier with a wire array thereof electrically bonded with the conductors to create with the magnetic cores a magnetic coil loop capable of providing a magnetic induction effect. In this way, the inductor manufactured in the present invention can achieve a higher inductance in a smaller volume.

### 2. Description of the Related Art

With the rapid growth of electronic technology, active components and passive components are widely used on internal circuit boards of electronic products. Active components (such as microprocessors or IC chips) can perform arithmetic and processing functions alone. However, passive components (such as resistors, capacitors and inductors, etc.) will maintain their resistance or impedance when the applied current or voltage is changed. In application, active components and passive components are used in information, communication and consumer electronic products to achieve electronic loop control subject to matching of circuit characteristics between components.

Further, an inductor generates electromotive force due to changes in current passing through the circuit, thereby resisting changes in current. There are many types of inductors. Inductors often used as electromagnets and transformers are known as coil that can provide high resistance to high frequency. An inductor for use to block higher-frequency alternating current (AC) in an electrical circuit, while passing lower-frequency or direct current (DC) is often referred to as choke or choke ring. Large inductors used with ferromagnetic materials in transformers, motors and generators are called windings. Inductors according to the electromagnetic induction can be divided into self-induction and mutual induction. When the wire turns wound round the magnetic body (such as magnetic core or ferromagnetic material) increases, the inductance will also become larger. The number of wire turns, the area of the wire turns (loop) and the wire material will affect the inductance size.

An inductor typically consists of an insulated wire wound into a coil around a ferromagnetic magnetic core or a core material with a higher magnetic permeability than the air. When the current flowing through the inductor changes, the time-varying magnetic field induces a voltage in the conductor. However, in actual applications, conventional inductors still have drawbacks as follows:

(1) When the insulated wire is wound into a coil around the ferromagnetic core, uneven winding of the coil often occurs due to differences in manual winding distribution, and the stray capacitance on the inductor will be difficult to control, resulting in differences between the noise suppression capabilities of same specification coils. Thus, the exact distance between the coil windings must be controlled. Due to small core volume, the manual winding method takes a lot of man-hours. Further, manual winding is not practical for mass production so that the manufacturing cost cannot be reduced.

(2) In order to obtain a larger amount of inductance, the coil windings will generally be overlapped, however, the insulative layer of the enameled wire can easily be scratched during the winding process. Further, overlapping the coil windings of the insulated wire around the ferromagnetic core will greatly increase the dimension of the inductor, in sequence, the inductor will require a relatively larger circuit board mounting surface to affect the overall circuit layout. When bonding the leads of the coil of the inductor to a circuit board, the large volume of the coil can touch other electronic components on the circuit board, causing coil damage and affecting the electrical characteristics and charge and discharge functions of the inductor.

Therefore, the conventional inductor manufacturing method of manually winding the coil is time-consuming and labor-intensive and costly and cannot be mass-produced. Further, inductor made according to the prior art design is bulky, occupies space on the circuit board, and affects the electrical characteristics and charging and discharging functions. How to solve the problems of the prior art design is the direction of the relevant manufacturers in this industry who want to study and improve.

### SUMMARY OF THE INVENTION

The present invention has been accomplished under the circumstances in view. It is therefore the main object of the present invention to provide an inductor molded on an insulative plastic block, which improves the manufacturing quality and yield, achieving the effects of simple structure, ease of installation, high production efficiency and cost effectiveness.

To achieve this and other objects of the present invention, an inductor molded on an insulative plastic block comprises an insulative plastic block, a positioning unit and a plurality of conductors. The insulative plastic block comprises a block base that defines therein a recessed open chamber. The positioning unit comprises a plurality of U-shaped plates arranged in rows in the recessed open chamber in a staggered manner. The conductors are respectively formed on the U-shaped plates and spaced from one another, each having two opposite ends thereof respectively terminating in a lead outside the block base.

Preferably, the insulative plastic block further comprises a plurality of partition plates mounted in the recessed open chamber and arranged in an array and dividing the recessed open chamber into a plurality of parallel channels. The U-shaped plates are respectively mounted in the channels in a horizontally staggered manner with respective opposite ends thereof protruding over the block base. Further the width of the odd-numbered rows of U-shaped plates of the positioning unit in the channels of the block base of the insulative plastic block in the direction from an outer side of the block base toward an inner side thereof is larger than the width of the even-numbered rows of U-shaped plates of the positioning unit and the depth of the odd-numbered rows of U-shaped plates is larger than the depth of the even-numbered rows of U-shaped plates so that the conductors formed on the odd-numbered rows of U-shaped plates are respectively spaced from the conductors formed on the even-numbered rows of U-shaped plates. The inductor further comprises a magnetic conductive component and a connection carrier. The magnetic conductive component comprises a magnetic core that has a plurality of slots cut through opposing top and bottom sides thereof. The magnetic core is mounted in the recessed open chamber of the block base in such a manner that the U-shaped plates of the positioning unit are inserted into the slots of the magnetic core to keep one lead of each conductor in one slot of the magnetic core and the other lead of each conductor outside the magnetic core so that the leads of the conductor have respective end portions thereof respectively located on respective opposite ends of the respective U-shaped plates outside the block base to provide a respective lead junction in a coplanar relationship. The connection carrier comprises a substrate, and a wire array located on the substrate and electrically bonded with the leads of the conductors. The wire array comprises a plurality of contact sets. Each contact set comprises a plurality of contacts respectively bonded to the lead junctions of the end portions of the respective leads by surface mount technology to create a magnetic coil loop.

Preferably, the magnetic core of the magnetic conductive component is selectively made of a non-conductive ferrite or ceramic material. The non-conductive ferrite includes soft ferrite and hard ferrite. The soft ferrite includes manganese zinc ferrite (MnZn) and nickel zinc ferrite (NiZn). The hard ferrite includes barium ferrite (SrFe₁₂O₉), barium ferrite (BaFe₁₂O₉) and cobalt ferrite (CoFe₂O₄). Alternatively, the magnetic core of the magnetic conductive component can be made of a conductive material selected from the group of iron, cobalt, zinc, nickel and their alloys, and then coated with an insulating layer.

Preferably, the conductors are formed on the U-shaped plates of the positioning unit in the recessed open chamber in the block base of the insulative plastic block by laser direct structuring (LDS) technology. The magnetic cores of the magnetic conductive components are set in the recessed open chamber in the block base of the insulative plastic block with the U-shaped plates of the positioning unit inserted into the slots of the magnetic cores to keep one lead of each conductor in one slot of one respective magnetic core and the other lead of each conductor outside the respective magnetic core, enabling the leads to be bonded to the contacts of the respective contact sets of wire array of the connection carrier to create a magnetic coil loop capable of providing a magnetic induction effect. After bonding of the conductors to the respective contact sets of the wire array, a continuous winding type coil loop. The direction and density of the multiple conductors can be precisely controlled according to actual needs, ensuring the quality and yield of the manufacturing, thereby achieving the advantages of simple structure, improved production efficiency and cost saving.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique elevational view of an insulative plastic block for inductor in accordance with the present invention.

FIG. 2 is an exploded view of an inductor molded on an insulative plastic block in accordance with the present invention.

FIG. 3 is a sectional front view of the inductor in accordance with the present invention.

### DETAILED DESCRIPTION OF THE PREFERRED EMBODIMENT

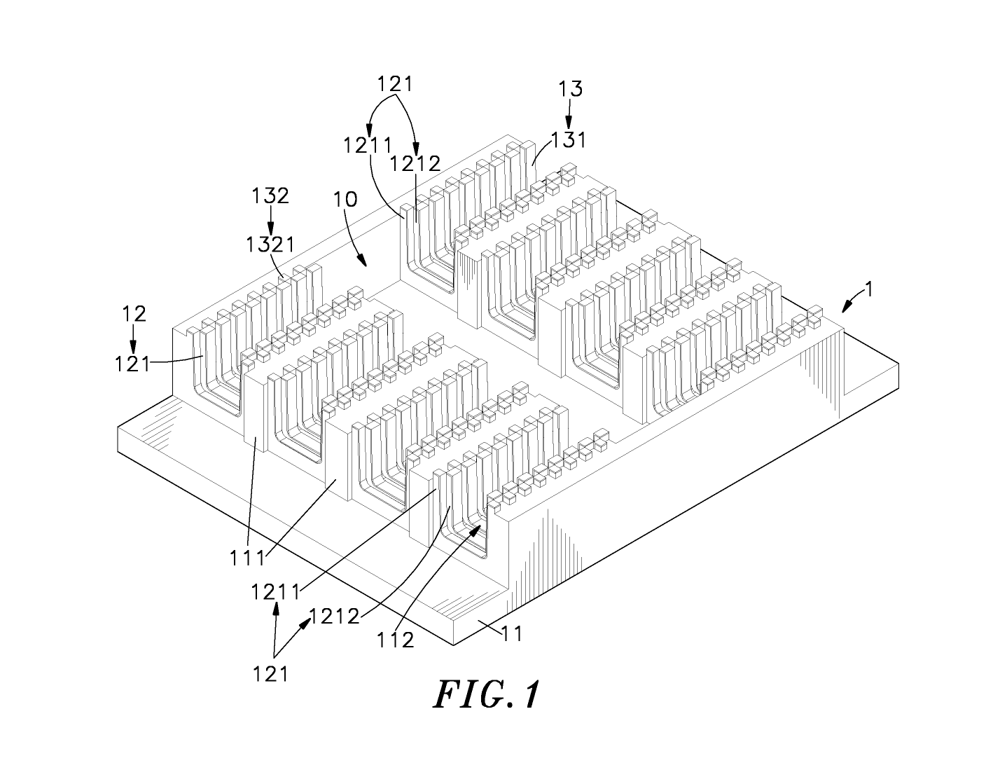

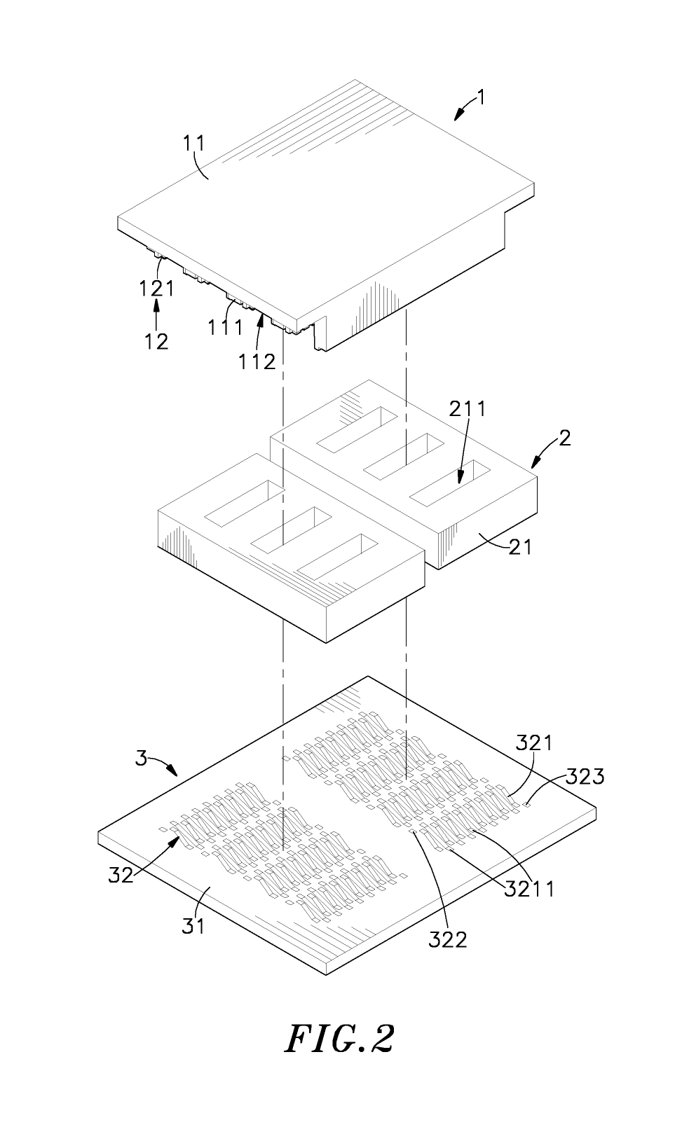

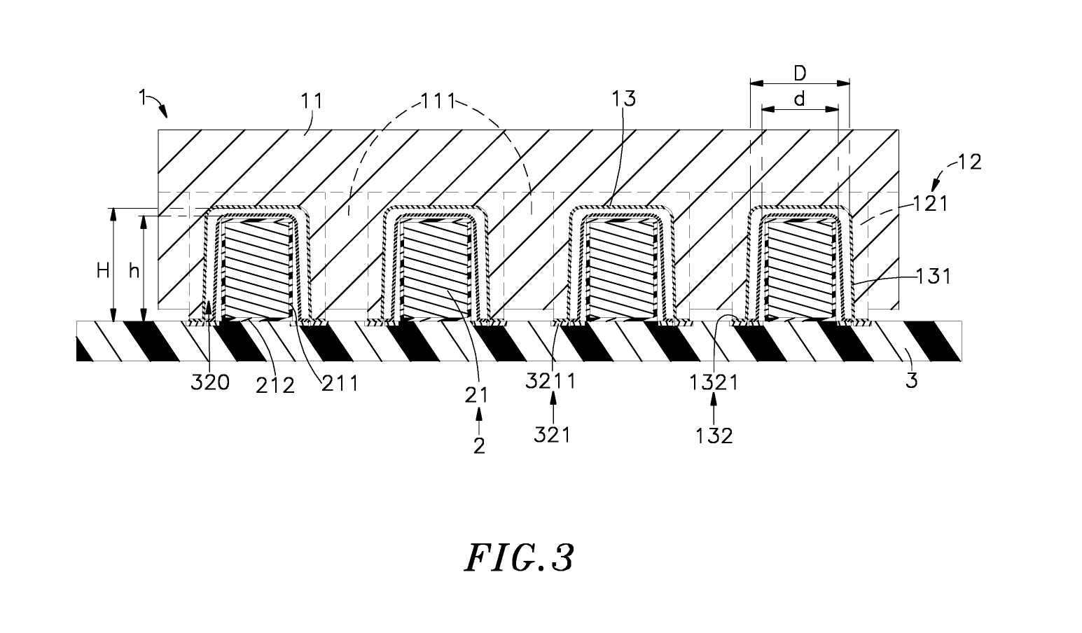

Referring to FIGS. 1-3, an inductor molded on an insulative plastic block in accordance with the present invention is shown. As illustrated, the inductor molded on an insulative plastic block comprises an insulative plastic block 1, a plurality of magnetic conductive components 2 and a connection carrier 3.

The insulative plastic block 1 comprises a block base 11 that is made from a plastic material in one piece by injection molding and defines a recessed open chamber 10 in a top side thereof, a plurality of partition plates 111 mounted in the recessed open chamber 10 and arranged in an array and dividing the recessed open chamber 10 into a plurality of parallel channels 112, a positioning unit 12 mounted in the channels 112, and conductors 13 formed on the positioning unit 12. The positioning unit 12 comprises a plurality of U-shaped plates 121 of two different widths and two different depths mounted in the channels 112 in a horizontally staggered manner with respective opposite ends thereof protruding over the block base 11. The U-shaped plates 121 with a first width and a first depth are arranged in odd-numbered rows. The U-shaped plates 121 with a second width and a second depth are arranged in even-numbered rows. Thus, different sizes of U-shaped plates 121 are alternatively arranged in the channels 112. Compared with the structure in which only single size U-shaped plates 121 are provided, the implementation structure of the present invention effectively utilizes the limited space of the insulating plastic block 1 for the winding of coils on the U-shaped plates 121 of two different sizes. In this way, the inductor manufactured in the present invention can achieve a higher inductance in a smaller volume, can be sold at a higher unit price in the commercial market, and has a greater flexibility in layout space when used in an electronic product. The conductors 13 are respectively formed of a conductive material on the U-shaped plates 121 by laser activation. These conductors 13 are spaced from one another. Each conductor 13 has two opposite ends thereof respectively terminating in a lead 131. The leads 131 of the conductors 13 have respective end portions 132 thereof respectively located on the opposite ends of the respective U-shaped plates 121 outside the block base 11 to provide a respective lead junction 1321. The lead junctions 1321 of the leads 131 of the conductors 13 are disposed in a coplanar relationship.

The magnetic conductive components 2 each comprise a magnetic core 21 in, for example, rectangular shape. The magnetic core 21 has a plurality of slots 211 cut through opposing top and bottom sides thereof.

The connection carrier 3 comprises a substrate 31 selected from, but not limited to, the group of bakelite, fiberglass, plastic sheet, ceramic and prepregs, and a wire array 32 made of a copper foil and located on a surface of the substrate 31. The wire array 32 comprises a plurality of contact sets 321 each comprising two staggered rows of contacts 3211, an input side 322 electrically connected with a first contact of each contact set 321, and an output side 323 electrically connected with a last contact of each contact set 321.

In installation, put the magnetic cores 21 of the magnetic conductive components 2 in the recessed open chamber 10 in the block base 11 of the insulative plastic block 1 to force the U-shaped plates 121 of the positioning unit 12 into the slots 211 of the magnetic cores 21, enabling one lead 131 of each conductor 13 to be disposed in one slot 211 of one respective magnetic core 21 and the other lead 131 of each conductor 13 to be disposed outside the respective magnetic core 21. At this time, the lead junctions 1321 of the end portions 132 of the leads 131 are disposed outside the insulative plastic block 1 and the magnetic cores 21. Thus, the conductors 13 are arranged side by side, in a ring or array, across the magnetic core 21. In this embodiment, the insulative plastic block 1 and the magnetic conductive components 2 are assembled at first. Further, when mounting the magnetic cores 21 in the block base 11, a glue dispensing technique is employed. However, in actual application, the assembly sequence may also be changed according to the manufacturing process or structural design. For example, the magnetic cores 21 of the magnetic conductive components 2 may be set on the connection carrier 3 first, and then assembled and soldered with the insulative plastic block 1. Thus, the insulative plastic block 1, the magnetic conductive components 2 and the connection carrier 3 are assembled to form an inductor.

In the present preferred embodiment, set the insulative plastic block 1 and the magnetic conductive components 2 on the substrate 31 of the connection carrier 3 to abut the lead junctions 1321 of the end portions 132 of the leads 131 of the conductors 13 at the contact sets 321 of the wire array 32 and the solder material (such as solder paste, solder balls or conductive adhesive) in forming a coplane, and then employ surface-mount technology (SMT) to bond the leads 131 of the conductors 13 to the contact sets 321 of the wire array 32, thereby forming the desired inductor (transformer or other inductance component). When an electric current is conducted to the input side 322 of the wire array 32, the electric current goes through an induction area 320 between the contact sets 321 and the conductors 13 to an external circuit via the output side 323. Subject to the magnetic induction effect of the magnetic coil loop formed by the magnetic cores 21 of the magnetic conductive components 2, the inductor of the present invention provides stable inductive effect and rectifying characteristic. The coil structural design of the conductors 13 formed of a conductive material on the positioning unit 12 of the insulative plastic block 1 by laser activation enables the dimension of the inductor to be minimized without increasing the overall height. Since the direction and density of multiple conductors 13 can be precisely controlled according to actual needs, the inductors can have the same or similar electrical characteristics to improve the manufacturing quality and yield, achieving the effects of simple structure, ease of installation, high production efficiency and cost effectiveness.

Further, a width (D) of the odd-numbered rows of U-shaped plate 1211 of the positioning unit 12 in the channels 112 of the block base 11 of the insulative plastic block 1 in the direction from the outer side of the block base 11 toward the inner side thereof is larger than a width (d) of the even-numbered rows of U-shaped plate 1211 of the positioning unit 12; a depth (H) of the odd-numbered rows of U-shaped plate 1211 is larger than the depth (h) of the even-numbered rows of U-shaped plate 1211; the U-shaped plates 1211 have respective opposite ends thereof protrude over the block base 11.

The leads 131 of the conductors 13 have respective end portions 132 thereof respectively located on the opposite ends of the respective U-shaped plates 121 outside the block base 11 to provide a respective lead junction 1321; the lead junctions 1321 of the leads 131 of the conductors 13 are disposed in a coplanar relationship; the leads 131 of the conductors 13 are respectively bonded with the wire array 32 of the connection carrier 3 to create magnetic coil loop capable of providing a magnetic induction effect.

Further, the conductors 13 are formed of a conductive material on the odd-numbered rows of U-shaped plate 1211 and even-numbered rows of U-shaped plates 1212 in the channels 112 of the block base 11 of the insulative plastic block 1 by laser direct structuring (LDS). The laser direct structuring (LDS) to form the conductors 13 on the odd-numbered rows of U-shaped plate 1211 and even-numbered rows of U-shaped plates 1212 is a laser technique in 3D-MID (Three-dimensional Molded Interconnect Device) technology. First, a laser activation process is performed, and the surface tin anti-etch resist on each of the odd-numbered rows of U-shaped plate 1211 and even-numbered rows of U-shaped plates 1212 is burned by the activation of the laser beam to generate a physical chemical reaction to form a metal core, and thus, a rough surface is formed on each of the odd-numbered rows of U-shaped plate 1211 and even-numbered rows of U-shaped plates 1212. The conductive material (which may be copper, zinc or nickel or its alloy material.) is attached to the rough surface of each of the odd-numbered rows of U-shaped plate 1211 and even-numbered rows of U-shaped plates 1212 during metallization to form a metal layer. Metallization is then employed to the metal layer on each of the odd-numbered rows of U-shaped plate 1211 and even-numbered rows of U-shaped plates 1212 to form a circuit (copper or nickle) of about 5 to 8 μm (micrometer) on the metal layer of the conductive material on the odd-numbered rows of U-shaped plate 1211 and even-numbered rows of U-shaped plates 1212, i.e., to form the aforesaid conductors 13 on the odd-numbered rows of U-shaped plate 1211 and even-numbered rows of U-shaped plates 1212 that are spaced from one another without contact.

In installation put the magnetic cores 21 of the magnetic conductive components 2 in the channels 112 in the block base 11 of the insulative plastic block 1 to force the U-shaped plates 121 of the positioning unit 12 into the slots 211 of the magnetic cores 21 to keep one lead 131 of each conductor 13 in one slot 211 of one respective magnetic core 21 and the other lead 131 of each conductor 13 outside the respective magnetic core 21, enabling the lead junctions 1321 of the end portions 132 of the leads 131 to be disposed outside the insulative plastic block 1 and the magnetic cores 21. Thus, the conductors 13 are placed across the magnetic cores 21 in a side by side configuration, a ring pattern or an array.

In this embodiment, the insulative plastic block 1 and the magnetic conductive components 2 are assembled at first. Further, when mounting the magnetic cores 21 in the block base 11, a glue dispensing technique is employed. However, in actual application, the assembly sequence may also be changed according to the manufacturing process or structural design. For example, the magnetic cores 21 of the magnetic conductive components 2 may be set on the connection carrier 3 first, and then assembled and soldered with the insulative plastic block 1. Thus, the insulative plastic block 1, the magnetic conductive components 2 and the connection carrier 3 are assembled to form an inductor in accordance with a second embodiment of the present invention.

Furthermore, the magnetic cores 21 of the magnetic conductive components 2 in the above embodiments of the present invention may be made of a conductive material, such as iron, cobalt, zinc, nickel or an alloy thereof. An insulating layer 212 which may be an insulating varnish is formed on the outer surface of the magnetic cores 21.

In the aforesaid embodiments, the magnetic cores 21 of the magnetic conductive components 2 can be made of a conductive material or a non-conductive material. For example, the magnetic cores 21 of the magnetic conductive components 2 can be made of a non-conductive ferrite or ceramic material. Ferrite is generally a non-conductive ferrimagnetic ceramic material. Similar to other metal oxides, ferrite has high hardness and brittleness, and is classified as “soft ferrite (soft magnet) and “hard ferrite (hard magnet)” according to its magnetic “coercivity”. The magnetic coercive force of “soft ferrite” is low, the magnetization of the material can be changed from positive to negative without consuming a lot of energy (hysteresis), and the high resistivity of the material itself also reduces another source of energy loss: eddy current generation. “Soft ferrite” may include manganese zinc ferrite (MnZn, chemical formula: MnₐZn₍₁₋ₐ₎Fe₂O₄) or nickel zinc ferrite (NiZn, chemical formula: NiₐZn₍₁₋ₐ₎Fe₂O₄). “Hard ferrite” is a “ferrite” that can be used in “permanent magnets”. It has a high magnetic “coercive force” and remanence after magnetization. “Hard ferrite” is not easily demagnetized, but can generate magnetic flux, has high magnetic permeability, and can be called “ceramic magnet”. “Hard ferrite” may include barium ferrite SrFe₁₂O₉(SrO.6Fe₂O₃), barium ferrite BaFe₁₂O₉ (BaO.6Fe₂O₃) or cobalt ferrite CoFe₂O₄ (CoO.Fe₂O₃). When a non-conductive material is used to make the magnetic cores 21 of the magnetic conductive components 2, it is not necessary to form the insulating layer 212 on the magnetic cores 21.

As stated above, the U-shaped plates 121 of the positioning unit 12 are arranged in the block base 11 of the insulative plastic block 1 in an array; the conductors 13 are respectively formed of a conductive material on the respective U-shaped plates 121 by laser activation and by laser direct structuring (LDS) technology. After removal of a part of the conductive material in the laser direct structuring (LDS) process, the conductors 13 are formed on the respective U-shaped plates 121 and spaced from one another by a predetermined gap (for example, 1 mm, 1.5 mm, 2 mm, 2.5 mm or 3 mm).

The magnetic cores 21 of the magnetic conductive components 2 are set in the recessed open chamber 10 in the block base 11 of the insulative plastic block 1 with the U-shaped plates 121 of the positioning unit 12 inserted into the slots 211 of the magnetic cores 21 to keep one lead 131 of each conductor 13 in one slot 211 of one respective magnetic core 21 and the other lead 131 of each conductor 13 outside the respective magnetic core 21, enabling the lead junctions 1321 of the end portions 132 of the leads 131 to be disposed outside the insulative plastic block 1 and the magnetic cores 21 and bonded to the contacts 3211 of the respective contact sets 321 of wire array 32 of the connection carrier 3 to create a magnetic coil loop capable of providing a magnetic induction effect. The direction and density of the multiple conductors 13 can be precisely controlled according to actual needs, ensuring the quality and yield of the manufacturing, thereby achieving the advantages of simple structure, improved production efficiency and cost saving.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An inductor molded on an insulative plastic block, comprising:
an insulative plastic block comprising a block base, said block base defining therein a recessed open chamber;
a positioning unit mounted in said recessed open chamber, said positioning unit comprising a plurality of U-shaped plates arranged in rows in said recessed open chamber in a staggered manner; and
a plurality of conductors respectively formed on said U-shaped plates and spaced from one another, each said conductor having two opposite ends thereof respectively terminating in a lead outside said block base.

2. The inductor as claimed in claim 1, wherein said insulative plastic block further comprises a plurality of partition plates mounted in said recessed open chamber and arranged in an array and dividing said recessed open chamber into a plurality of parallel channels; said U-shaped plates are respectively mounted in said channels in a horizontally staggered manner with respective opposite ends thereof protruding over said block base.

3. The inductor as claimed in claim 2, wherein a width of odd-numbered rows of said U-shaped plates of said positioning unit in said channels of said block base of said insulative plastic block in the direction from an outer side of said block base toward an inner side thereof is larger than a width of even-numbered rows of said U-shaped plates of said positioning unit and a depth of the said odd-numbered rows of said U-shaped plates is larger than a depth of the said even-numbered rows of said U-shaped plates so that said conductors formed on said odd-numbered rows of said U-shaped plates are respectively spaced from the said conductors formed on the said even-numbered rows of said U-shaped plates.

4. The inductor as claimed in claim 3, wherein said conductors are respectively formed of a conductive material on each surface of said odd-numbered rows of said U-shaped plates and said even-numbered rows of said U-shaped plates by laser activation.

5. The inductor as claimed in claim 3, wherein said conductors are respectively formed of a conductive material on each said surface of said odd-numbered rows of said U-shaped plates and said even-numbered rows of said U-shaped plates by laser direct structuring technology, and spaced from one another by a gap of 1 mm, 1.5 mm, 2 mm, 2.5 mm or 3 mm.

6. The inductor as claimed in claim 2, wherein each said U-shaped plate has two opposite ends thereof protruding over said block base; said leads of said conductors have respective end portions thereof respectively located on the opposite ends of the respective said U-shaped plates outside said block base to provide a respective lead junction, said lead junctions of said leads of said conductors being disposed in a coplanar relationship.

7. The inductor as claimed in claim 1, further comprising:
a magnetic conductive component comprising a magnetic core, said magnetic core having a plurality of slots cut through opposing top and bottom sides thereof, said magnetic core being mounted in said recessed open chamber of said block base in such a manner that said U-shaped plates of said positioning unit are inserted into said slots of said magnetic core to keep one lead of each said conductor in one said slot of said magnetic core and the other said lead of each said conductor outside said magnetic core so that said leads of said conductors have respective end portions thereof respectively located on respective opposite ends of the respective said U-shaped plates outside said block base to provide a respective lead junction in a coplanar relationship; and
a connection carrier comprising a substrate and a wire array located on said substrate and electrically bonded with said leads of said conductors, said wire array comprising a plurality of contact sets, each said contact set comprising a plurality of contacts respectively bonded to said lead junctions of said end portions of said leads by surface mount technology to create a magnetic coil loop, said leads of said conductors have respective end portions thereof respectively located on the opposite ends of said positioning unit outside the block base to provide a plurality of lead junctions; said lead junctions of the leads of the conductors are disposed in a coplanar relationship, said lead junctions of said end portions of said leads of said conductors abut at said contact sets of said wire array and a solder material in forming a co-plane, and then employ surface-mount technology to bond said leads of said conductors to said contact sets of said wire array, forming electrical contact.

8. The inductor as claimed in claim 7, wherein said magnetic core of said magnetic conductive component is selectively made of a conductive material or a non-conductive material.

9. The inductor as claimed in claim 7, wherein said magnetic core of said magnetic conductive component is selectively made of a non-conductive ferrite or ceramic material, said non-conductive ferrite including soft ferrite and hard ferrite, said soft ferrite including manganese zinc ferrite (MnZn) and nickel zinc ferrite (NiZn), said hard ferrite including barium ferrite (SrFe₁₂O₉), barium ferrite (BaFe₁₂O₉) and cobalt ferrite (CoFe₂O₄).

10. The inductor as claimed in claim 7, wherein said magnetic core of said magnetic conductive component is made of a conductive material selected from the group of iron, cobalt, zinc, nickel and their alloys, and then coated with an insulating layer.
